(19) United States
(12) Patent Application Publication
(10) Pub. No.: US 2005/0213459 A1
(43) Pub. Date: Sep. 29, 2005

(54) Optical-recording-medium reading apparatus

(75) Inventors: Yoshimichi Nishio, Saitama (JP); Yasuhisa Okamoto, Saitama (JP); Takehiro Takada, Saitama (JP); Yoshihiro Hashizuka, Saitama (JP); Hiroki Goto, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/080,667

(22) Filed: Mar. 16, 2005

(30) Foreign Application Priority Data
Mar. 17, 2004 (JP) 2004-75877

(51) Int. Cl. G11B 5/09

(52) U.S. Cl. 369/59.1

(57) ABSTRACT

An imaging unit captures an image of an entire recording surface of an optical recording medium. An image storing unit stores the image captured as one image of a recording surface image. A track-information calculating unit calculates a virtual center point and an actual track pitch of the optical recording medium. An image-analysis-path generating unit matches a center of an image analysis path with the virtual center point of the recording surface image stored. An image analyzing unit performs an image analysis of the pits sequentially from an innermost periphery according to the image analysis path, and converts the pit arrangement information of the track into a digital signal, and stores the digital signal converted.

### BACKGROUND OF THE INVENTION

1) Field of the Invention

The present invention relates to an optical-recording-medium reading apparatus that performs an image analysis of an arrangement of pit strings recorded on an optical recording medium to convert pit arrangement information into a digital signal.

2) Description of the Related Art

In general, optical recording media like a compact disk (CD), a compact disk-read only memory (CD-ROM), and a digital versatile disk (DVD) are reproduced by an optical recording medium reproducing apparatus having an optical pickup. This optical recording medium reproducing apparatus reads pit strings formed as one track on a recording surface of an optical recording medium while rotating the optical recording medium at high speed. The optical recording medium is displaced in a horizontal direction and a vertical direction while the optical recording medium is rotated. A tracking servo and a focusing servo are provided in the optical pickup such that the pit strings can be read along the track even in such a state. However, a control mechanism for the focusing servo floats an actuator thereof in a space electromagnetically such that a lens can be moved up and down to a target of focusing. Thus, when a disturbance like an impact occurs, a reading signal generated by the optical pickup may be interrupted.

Therefore, an optical-recording-medium reading apparatus has been proposed to eliminate such an influence, which picks up an image of pit strings formed on a recording surface of an optical recording medium using a laser beam, which is used for reproduction, to store image data of the pit strings. Then, the optical-recording-medium reading apparatus obtains pit length information including lengths and intervals of pits forming the pit strings from this image data to generate a reading signal based on this pit length information (see, for example, Japanese Patent Application Laid-Open No. 2001-202626).

However, the conventional optical-recording-medium reading apparatus picks up an image of pit strings for generating an original reading signal first and, then, further picks up an image of the pit strings to correct eccentricity and fluctuation in a linear velocity of the optical recording medium due to rotation of the optical recording medium. Since it is necessary to pick up an image of the pit strings twice to obtain the pit length information, processing for generating the reading signal is complicated. This is an example of problems that the present invention is to solve.

### SUMMARY OF THE INVENTION

It is an object of the present invention to solve at least the above problems in the conventional technology.

An optical-recording-medium reading apparatus according to one aspect of the present invention, which applies image analysis to an image of a track consisting of strings of optically readable pits formed on a recording surface of an optical recording medium, and converts pit arrangement information including lengths and intervals of the pits into a digital signal, includes an imaging unit that captures an image of an entire recording surface of the optical recording medium; an image storing unit that stores the image of the entire recording surface captured as one image of a recording surface image; a track-information calculating unit that calculates a virtual center point that is a center of the track of the optical recording medium and an actual track pitch that is an interval between adjacent pit strings of the track in a radial direction of the optical recording medium; an image-analysis-path generating unit that matches a center of an image analysis path with the virtual center point of the recording surface image stored in the image storing unit, the image analysis path being obtained by transforming a standard image analysis path of a spiral shape for performing the image analysis of pits from an innermost periphery to an outermost periphery of the track having a standard track pitch that is set according to a type of the optical recording medium to be superimposed on the actual track pitch calculated; and an image analyzing unit that performs the image analysis of the pits sequentially from the innermost periphery according to the image analysis path, and converts the pit arrangement information of the track into a digital signal, and stores the digital signal converted.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a schematic structure of an optical-recording-medium reading apparatus according to a first embodiment of the present invention;

FIG. 2A is a perspective view of a schematic structure of an imaging unit;

FIG. 2B is a diagram of an example of a method of picking up an image of a recording surface of an optical recording medium with the imaging unit;

FIG. 2C is a diagram of an example of the method of picking up an image of a recording surface of an optical recording medium with the imaging unit;

FIG. 3A is a plan view of a schematic structure of the recording surface of the optical recording medium;

FIG. 3B is a schematic diagram of a gap between a center point determined from a shape of the optical recording medium and a center point of a spiral track;

FIG. 3C is a diagram of an example of pit strings;

FIG. 4 is a diagram for explaining an outline of a method of calculating a track pitch;

FIG. 5 is a diagram of an example of a standard imaginary spiral;

FIG. 6 is a diagram of a state in which an imaginary spiral, which is transformed to match the optical recording medium is arranged on a recording surface image;

FIG. 7 is a flowchart of a procedure for operation processing of the optical-recording-medium reading apparatus;

FIG. 8 is a block diagram of a schematic structure of an optical-recording-medium reading apparatus according to a second embodiment of the present invention;

FIG. 9A is a diagram of a recording surface image subjected to image processing;

FIG. 9B is a diagram of an example of a method of expanding the recording surface image with an image expanding unit;

FIG. 10 is a diagram of an example of a standard analysis net included in an analysis net generating unit;

FIG. 11 is a diagram of an example of a structure of an imaging unit in a third embodiment of the present invention; and

FIG. 12 is a diagram of another example of the structure of the imaging unit in the third embodiment.

### DETAILED DESCRIPTION

Exemplary embodiments of the present invention will be explained in detail below with reference to the accompanying drawings. Note that in the following explanation, disk-like optical recording media such as a CD, a CD-ROM, and a DVD are explained as an example of an optical recording medium. However, it is also possible to apply the present invention to an optical recording medium like an optical card.

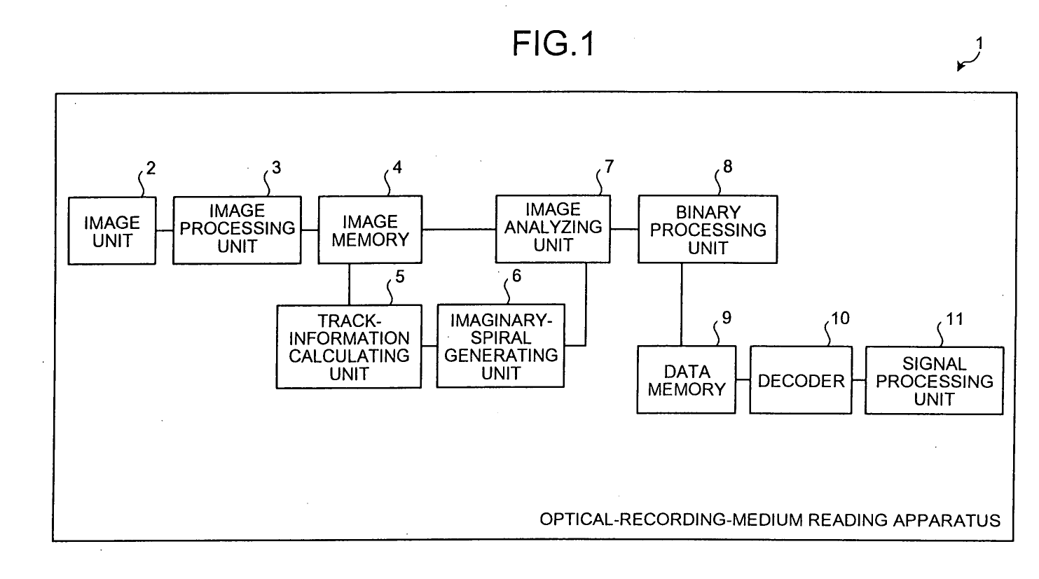

FIG. 1 is a block diagram of a schematic structure of an optical-recording-medium reading apparatus according to a first embodiment of the present invention. An optical-recording-medium reading apparatus 1 includes an imaging unit 2, an image processing unit 3, an image memory 4, a track-information calculating unit 5, an imaginary spiral generating unit 6, an image analyzing unit 7, a binary processing unit 8, a data memory 9, a decoder 10, and a signal processing unit 11. The imaging unit 2 picks up an image of a recording surface of an optical recording medium. The image processing unit 3 processes the picked-up image to form one recording surface image showing the entire optical recording medium. The image memory 4 stores the recording surface image. The track-information calculating unit 5 calculates track information including a pitch of a track and a center point of a spiral track from the recording surface image. The imaginary spiral generating unit 6 generates an imaginary spiral for subjecting pit strings on the recording surface image along the track to image analysis based on the track information. The image analyzing unit 7 applies image analysis to the recording surface image on the image memory 4 using the imaginary spiral. The binary processing unit 8 subjects a result of the image analysis to digital signaling (binary) processing. The data memory 9 stores data of the recording surface image changed to a digital signal. The decoder 10 converts the digital signal into an audio or a video signal according to a type of information to be recorded in the optical recording medium. The signal processing unit 11 generates a reproduction signal from the converted signal. Note that the imaginary spiral generating unit 6 corresponds to an image-analysis-path generating unit in patent claims and the image analyzing unit 7, the binary processing unit 8, and the data memory 9 correspond to an image analysis unit in patent claims.

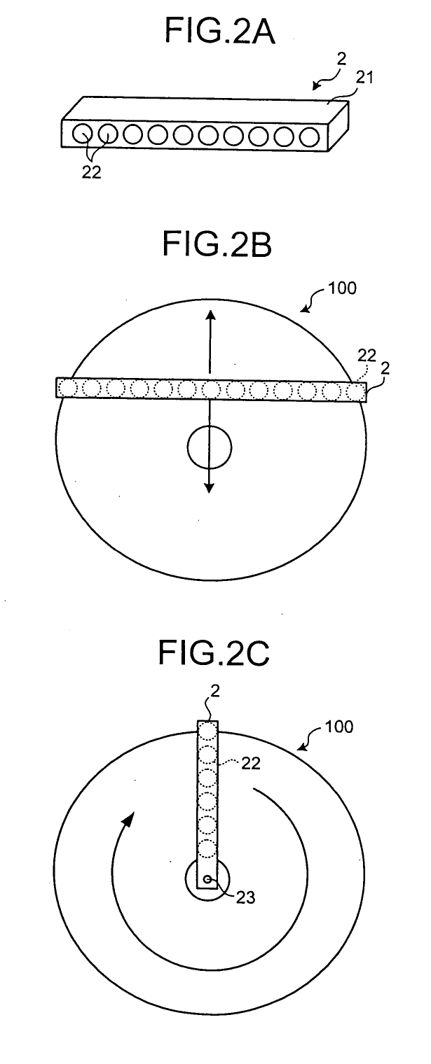

The imaging unit 2 picks up an image of the entire recording surface of the optical recording medium. FIG. 2A is a perspective view of a schematic structure of the imaging unit 2. As shown in the figure, in the imaging unit 2, plural image pickup devices 22 are arranged on one support member 21 side by side such that the imaging unit 2 can pickup an image of the entire recording surface of the optical recording medium. The image pickup devices 22 irradiate laser beams on the recording surface from a laser serving as a light source and detect reflected light of the laser beam with an imaging device such as a charge-coupled device (CCD). FIGS. 2B and 2C are diagrams of examples of a method of picking up an image of a recording surface of an optical recording medium with an imaging unit. In FIG. 2A, a length of the imaging unit 2 is substantially the same as a diameter of an optical recording medium 100. The imaging unit 2 or the optical recording medium 100 is moved in an arrow direction shown in the figure, whereby the imaging unit 2 picks up an image of a recording surface of the optical recording medium 100. In FIG. 2C, a length of the imaging unit 2 is substantially the same as a radius of the optical recording medium 100. The imaging unit 2 is supported by a fixed shaft in the center of the optical recording medium 100 at one end thereof to be rotatable in a plane parallel to the recording surface of the optical recording medium 100. In other words, the imaging unit 2 rotates in an arrow direction shown in the figure around the fixed shaft to pickup an image of the recording surface of the optical recording medium 100. Note that, in FIG. 2C, it is also possible that the imaging unit 2 is fixed and the optical recording medium 100 is rotated with the center of the optical recording medium 100 as an axis.

The image processing unit 3 has a function of combining images of an optical recording medium picked up by the respective image pickup devices 22 of the imaging unit 2 to form one recording surface image. The image memory 4 has a function of keeping a state of the recording surface image formed by the image processing unit 3.

The track-information calculating unit 5 has a function of calculating track information for correcting a gap between an eccentric component and a track pitch in reading arrangement information of pit strings of a spiral track using the recording surface image stored in the image memory 4. In other words, the track-information calculating unit 5 has a function of calculating a gap between an eccentric component and a track pitch from the recording surface image. Here, terms used in this specification concerning the structure of the optical recording medium are explained and, then, processing for calculating an eccentric component and processing for calculating a track pitch by the track-information calculating unit 5 are explained.

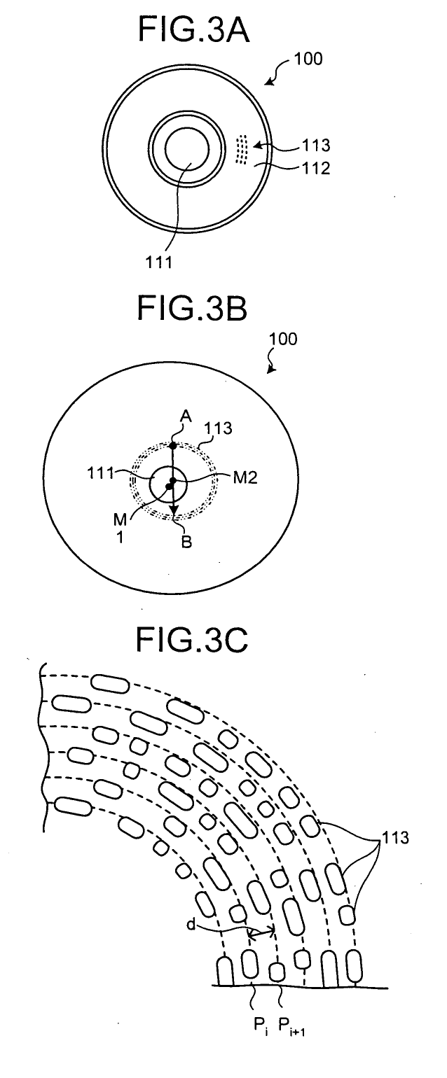

FIGS. 3A and 3B are plan views of a schematic structure of the recording surface of the optical recording medium. As shown in FIG. 3A, the optical recording medium 100 has a predetermined diameter according to a type of the optical recording medium 100. In a recording surface on a main body of the optical recording medium 100, a data area 112 is provided in a predetermined range from an inner periphery to an outer periphery with a center hole 111 as a center. Spiral pits 113 are recorded from one point in an innermost periphery to one point in an outermost periphery of this data area 112 with a part near the center of the center hole 111 as a center. Strings formed by the spiral pits 113 are referred to as a track. As shown in FIG. 3B, a center point M1 determined from a shape of the optical recording medium 100 and a center point (hereinafter, “virtual center point”) M2 of the spiral track do not always coincide with each other. A gap of both the center points is referred to as an eccentric component. FIG. 3C is a diagram of an example of strings of pits (pit strings) in a part of the recording surface of the optical recording medium. In this figure, broken lines, which are shown for convenience of explanation, indicate loci of the spiral track. As shown in the figure, an interval d in a radial direction of the optical recording medium 100 between a certain pit string Pᵢ and a pit string Pᵢ₊₁ adjacent to this pit string Pi is referred to as a track pitch. Note that a reference for the track pitch is set such that the track pitch has a predetermined value for each type of the optical recording medium 100. For example, the track pitch set by the reference is 1.6 micrometers in the case of a CD and is 0.74 micrometer in the case of a DVD.

As described above, in the optical recording medium 100, the center point M1 determined from a shape of the optical recording medium 100 and the virtual center point M2 do not always coincide with each other. When the pit strings are read spirally from a point in an innermost periphery in a recording surface image in a mechanical manner, the pit strings cannot be read accurately because deviation occurs. Therefore, for correction that is necessary when the pit strings are read, the track-information calculating unit 5 calculates an eccentric component. Here, as the calculation of the eccentric component, the track-information calculating unit 5 obtains the virtual center point M2 on the recording surface image. As shown in FIG. 3B, first, the track-information calculating unit 5 extracts a point A in an innermost periphery of the pit strings from the recording surface image and calculates a point B most distant from the point A in the pit string in the innermost periphery to obtain a midpoint of the point A and the point B. This midpoint is the virtual center point M2. It is possible to read the pit strings without deviating from the track by reading the track with this point as a center.

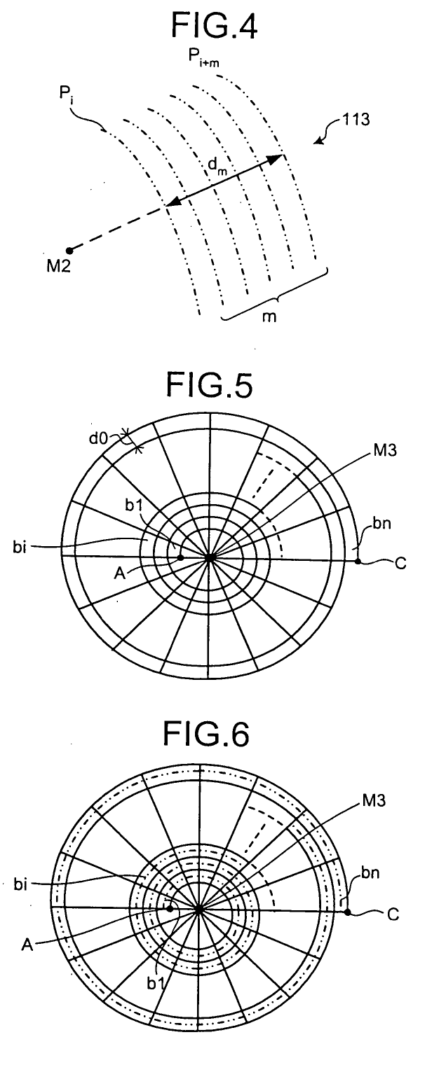

As explained with reference to FIG. 3C, the track pitch is usually set to be a predetermined value for each type of the optical recording medium 100. However, actually, the track pitch may be slightly different from the value set as the reference. For example, in the case of the CD, the track pitch may be 1.5 micrometers or 1.7 micrometers depending on a product. Thus, the track-information calculating unit 5 performs processing for calculating a track pitch. FIG. 4 is a diagram for explaining an outline of a method of calculating a track pitch. As shown in the figure, the track-information calculating unit 5 measures a distance dₘ between a pit string Pᵢ and a pit string Pᵢ₊ₘ that is m tracks (m is a positive integer) apart from the pit string Pᵢ. At this point, the track-information calculating unit 5 measures a distance on a line extending radially from the imaginary midpoint M2. Then, an actual track pitch is calculated as dₘ/m that is obtained by dividing the measured distance dₘ by the number of pit strings m between both the pit strings. The virtual center point M2 and the actual track pitch dₘ/m obtained as described above are output to the imaginary spiral generating unit 6.

The imaginary spiral generating unit 6 has a function of generating an imaginary spiral that is an image analysis path for reading information on an arrangement of pit strings formed on a recording surface image. The imaginary spiral generating unit 6 holds a standard imaginary spiral. Here, the standard imaginary spiral is explained. FIG. 5 is a diagram of an example of the standard imaginary spiral. An imaginary spiral 61 has plural sections bi (i is a positive integer). The sections bi are formed by a line spirally connects a point A of a pit string in an innermost periphery located at a distance, which is set according to a type of an optical recording medium, and a point C of a pit string in an outermost periphery in a data area at a standard track pitch d0, which is set according to the type of the optical recording medium, with a point M3 as a center and plural straight lines extending radially from the point M3. In the figure, a section located on an innermost periphery side is set as b1 and a section located on an outermost periphery side is set as bn (n is a positive integer). The standard imaginary spiral is formed in this way. Thus, if an optical recording medium is formed according to the standard that is set according to a type of the optical recording medium, pit strings of the optical recording medium are fit in the respective sections bi (i=1 to n). Note that this standard imaginary spiral corresponds to an image analysis path in patent claims.

The imaginary spiral generating unit 6 receives the virtual center point M2 and the actual track pitch dₘ/m from the track-information calculating unit 5. Then, the imaginary spiral generating unit 6 multiplies the track pitch d0 of the standard imaginary spiral 61 by (dₘ/m)/d0 and arranges the center point M3 of the standard imaginary spiral 61 to coincide with the virtual center point M2 on the recording surface image. Specifically, the imaginary spiral generating unit 6 compares the actual track pitch dₘ/m of the optical recording medium and the track pitch d0 of the standard imaginary spiral 61. When the former is smaller than the latter, the standard imaginary spiral is reduced. On the contrary, when the former is larger than the latter, the standard imaginary spiral is enlarged. When both the track pitches are the same, a size of the standard imaginary spiral is not changed. For example, in the case of the CD, since the standard track pitch is 1.6 micrometers, when an actual track pitch of the CD is 1.5 micrometers, the standard imaginary spiral is reduced to 0.9375 (=1.5/1.6) times as large. When the actual track pitch of the CD is 1.7 micrometers, the standard imaginary spiral is enlarged to 1.0625 (=1.7/1.6) times as large. FIG. 6 is a diagram schematically showing a state in which an imaginary spiral, which is transformed according to an optical recording medium, is arranged on a recording surface image. As shown in the figure, the pits 113 of the optical recording medium are fit in respective sections bi of a transformed imaginary spiral 62. Note that, actually, a part further on the outer side than a pit string in an innermost periphery of the standard imaginary spiral 61 is reduced or enlarged. When the imaginary spiral 62 is superimposed on the recording surface image, it is necessary to superimpose the imaginary spiral 62 such that the section b1 in an innermost periphery of the imaginary spiral 62 coincides with the pits in the innermost periphery of the optical recording medium. This imaginary spiral corresponds to the image analysis path in patent claims. Although the imaginary spiral is spiral as shown in FIG. 5, a shape of the imaginary spiral is not limited to this and may be any other shape.

The image analyzing unit 7 analyzes the recording surface image on which the imaginary spiral is superimposed by the imaginary spiral generating unit 6. Specifically, the imaginary spiral generating unit 6 performs processing for reading lengths of pits included in the respective sections and intervals of the pits in order from the section b1 in the innermost periphery to a section bn in an outermost periphery forming the imaginary spiral. For example, in the section bi, the image analyzing unit 7 reads pixel values of pits in order for each unit of lengths of the pits.

The binary processing unit 8 subjects a result of the image analysis in the image analyzing unit 7 to a binary processing. For example, the binary processing unit 8 binarizes a result of the image analysis in each of the sections bi depending on whether the pixel value read by the image analyzing unit 7 is equal to or larger than a predetermined value and stores the result of the image analysis in the data memory 9 as digital signal. Consequently, for example, a part where pits are present is represented by “0” and a part where pits are not present is represented by “1”. In this way, the information on an arrangement of pit strings recorded in the recording surface image is changed to digital information. This means that information on the recording surface image stored in the image memory 4 is digitized.

The data memory 9 stores the digital signal digitized (binarized) by the binary processing unit 8. The decoder 10 decodes the digital signal stored in the data memory 9 and converts the digital signal into an audio or video signal. The signal processing unit 11 reads the signal generated by the decoder 10, applies demodulation processing to the signal, and outputs the signal as a reproduction signal. This reproduction signal is output from a speaker as a sound or output to a display device as a video according to a type of the optical-recording-medium reading apparatus 1.

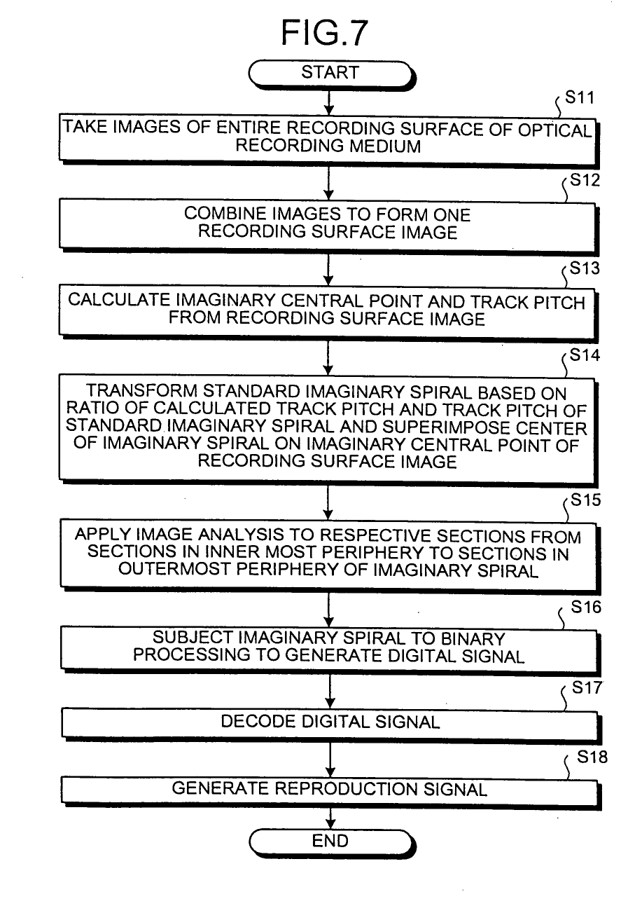

Next, a procedure of operation processing of this optical-recording-medium reading apparatus is explained with reference to a flowchart in FIG. 7. First, when an optical recording medium is mounted on a not-shown optical recording medium support stand of the optical-recording-medium reading apparatus 1 and reading processing is executed, the imaging unit 2 picks up images of an entire recording surface of the optical recording medium (step S11). Images picked up by the respective image pickup devices 22 of the imaging unit 2 are combined to be one recording surface image by the image processing unit 3 (step S12) and the recording surface image is stored in the image memory 4. The track-information calculating unit 5 calculates a virtual center point, which is a center point of a track consisting of pit strings, and an actual track pitch from the recording surface image stored in the image memory 4 (step S13). Based on a ratio of the calculated actual track pitch and a track pitch of a standard imaginary spiral held by the imaginary spiral generating unit 6 itself, the imaginary spiral generating unit 6 generates an imaginary spiral by reducing or enlarging the standard imaginary spiral and superimposes a center point of the generated imaginary spiral on the calculated virtual center point on the recording surface image (step S14).

Thereafter, the image analyzing unit 7 uses the recording surface image, on which the imaginary spiral is superimposed, to subject the imaginary spiral to image analysis from a section in an innermost periphery to a section in an outermost periphery of the imaginary spiral and obtain information on an arrangement of the pit strings (step S15). In this case, in the respective sections, the image analyzing unit 7 performs the image analysis with a minimum value, which is a reference of lengths of pits, as a unit. Subsequently, the binary processing unit 8 applies binary processing to the information on an arrangement of the pit strings, which is obtained for the respective sections from the section in the innermost periphery to the section in the outermost periphery of the imaginary spiral subjected to the image analysis, to generate a digital signal (step S16) and stores the digital signal in the data memory 9. The decoder 10 decodes the digital signal stored in the digital memory 9 to generate a signal such as an audio signal or a video signal (step S17). The signal processing unit 11 subjects the signal such as an audio signal or a video signal to demodulation processing to generate a reproduction signal (step S18). Here, the processing for reading the optical recording medium by the optical-recording-medium reading apparatus 1 ends.

According to the first embodiment, an image of the entire recording surface of the optical recording medium is picked up at a time. Thus, it is possible to perform the processing for obtaining a gap of an eccentric component and a track pitch and the processing for reading pit strings on one recording surface image. As a result, steps of the processing are simplified. In addition, an image analysis path for reading track pitches of a recording screen image in order from pits in an innermost periphery is transformed based on track information, which is the gap of the eccentric component and the track pitch, and superimposed on the recording surface image. Thus, it is possible to read pits along a track when image analysis processing is performed.

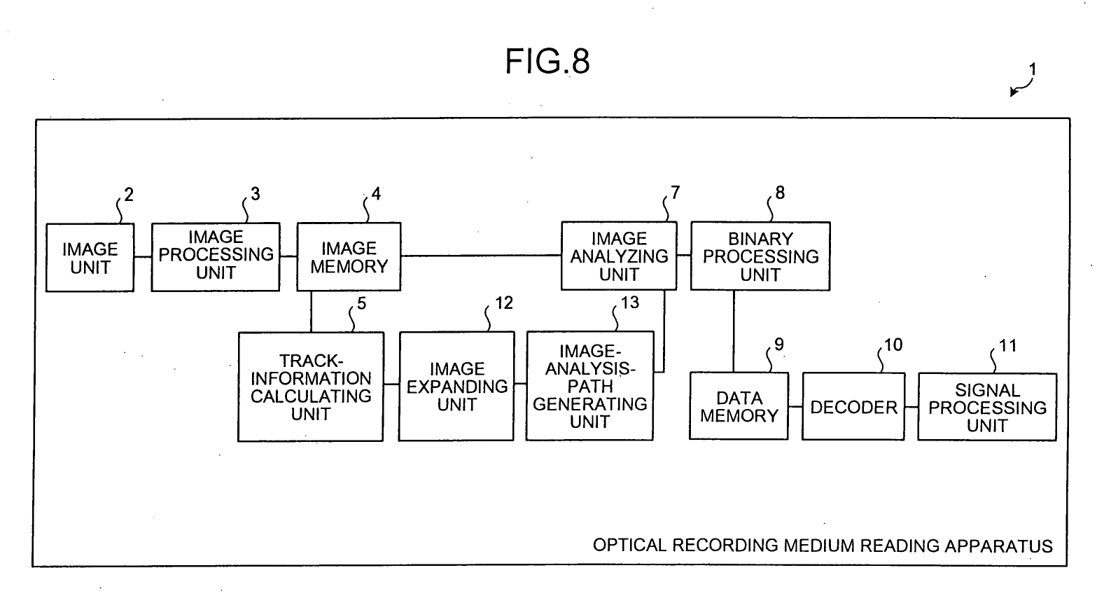

FIG. 8 is a block diagram of a schematic structure of an optical-recording-medium reading apparatus according to a second embodiment of the present invention. The optical-recording-medium reading apparatus 1 further includes an image expanding unit 12, which expands a recording surface image stored in the image memory 4, in addition to the units of the optical-recording-medium reading apparatus 1 according to the first embodiment shown in FIG. 1. Moreover, the optical-recording-medium reading apparatus 1 includes an image-analysis-path generating unit 13, which generates an image analysis path for applying image analysis to the expanded image, instead of the imaginary spiral generating unit 6.

The track-information calculating unit 5 has a function of obtaining an amount of deviation of an actual distance between the actual center point M1 and the virtual center point M2 of the optical recording medium 100 in FIG. 3B.

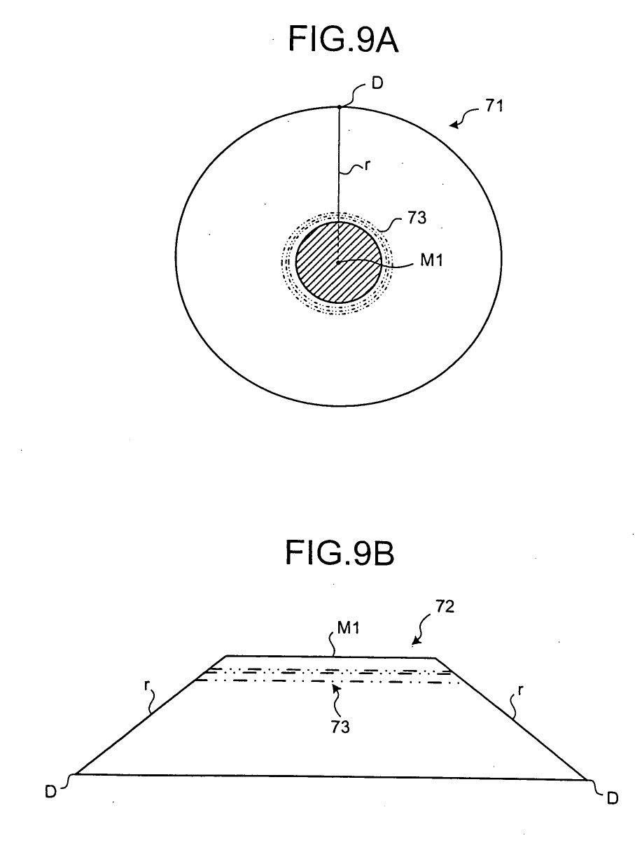

The image expanding unit 12 has a function of expanding the recording surface image, which is formed as one image by the image processing unit 3, such that an arc in an outer periphery of the optical recording medium changes to a straight line and storing the expanded image in the image memory 4. FIGS. 9A and 9B are diagrams of an example of a method of expanding a recording surface image with an image expanding unit. FIG. 9A is a recording surface image 71 that is picked up by the imaging unit 2 and subjected to image processing by the image processing unit 3. In this recording surface image 71, a straight line r connecting the center point M1 of the optical recording medium and one point D on the outer periphery thereof is drawn and the image is expanded from the straight line r such that an arc forming the outer periphery changes to a straight line. In this expansion, it is preferable to expand the image with the straight line r passing a point of a pit string in an innermost periphery as a reference. FIG. 9B is a diagram of an image expanded in this way (hereinafter, “expanded recording surface image 72”). By changing the recording surface image to the expanded recording surface image 72 in this way, strings of pits 73 forming a track change to substantially a linear shape and is easily analyzed. Note that, when the central position M1 of the optical recording medium and the virtual center point M2, which is a center point of the track, deviate from each other, pit strings assumes a sine curve shape.

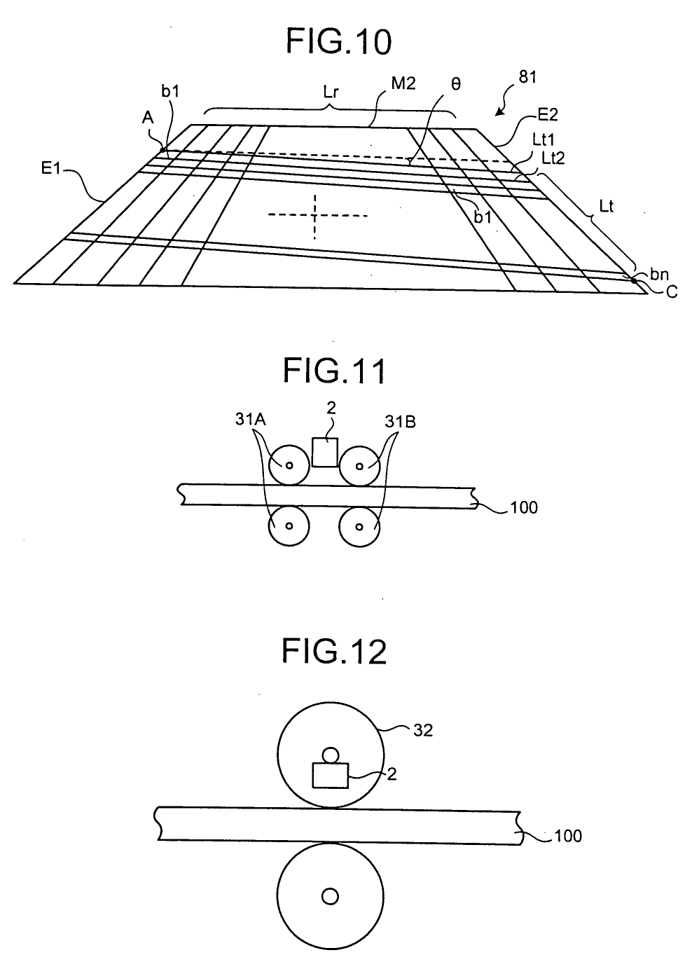

The image-analysis-path generating unit 13 basically has the same function as the imaginary spiral generating unit 6 in the first embodiment. However, in the second embodiment, the image-analysis-path generating unit 13 generates an image analysis path for analyzing pit strings in line with the expansion of the recording surface image. The image-analysis-path generating unit 13 holds a standard image analysis path in the same manner as the imaginary spiral generating unit 6 in the first embodiment. FIG. 10 is a diagram of an example of the standard image analysis path held by the image-analysis-path generating unit 13. An image analysis path 81 has the same shape as the expanded optical recording medium. The image analysis path 81 includes plural sections bi (i is a positive integer) formed by plural straight lines Lt, which have a predetermined inclination with respect to a linear upper side or lower side of the image analysis path 81 and extend in a track direction, and straight lines Lr, which extend in a radial direction of the optical recording medium.

To explain how the image analysis path 81 is formed more specifically, first, the image-analysis-path generating unit 13 draws a straight line Lt1 having an inclination θ with respect to the upper side or the lower side on an inner peripheral side of the optical recording medium with a point A of a pit string on an innermost periphery as a starting point. Next, the image-analysis-path generating unit 13 draws a straight line Lt2 parallel to the straight line Lt1 with a point on a side E1 of the image analysis path, which is at a distance from the virtual center point M2 equal to a distance from the virtual center point M2 to an end point of the straight line Lt1 on the side E2 of the image analysis path, as a starting point. The image-analysis-path generating unit 13 repeats such operation until the straight lines Lt are drawn up to a point C of a pit string in an outermost periphery of data area. The straight lines Lt have the inclination θ with respect to the upper side or the lower side of the image analysis path because pit strings on the optical recording medium form a track spirally at a track pitch of d0. Therefore, a distance between the adjacent straight lines Lt is equivalent to the track pitch d0. In this way, the image-analysis-path generating unit 13 draws the straight lines Lt in the track direction. On the other hand, the image-analysis-path generating unit 13 draws the straight lines Lr for each predetermined angle such that a direction of the straight lines Lr coincides with the radial direction of the optical recording medium. The plural sections bi are formed by the straight lines Lt and Lr crossing each other. Among the sections bi, a section including a pit A located on the innermost peripheral side is set as b1 and a section including a pit C located on the outermost peripheral side is set as bn (n is a positive integer). By forming the standard image analysis path in this way, the actual center point M1 of the optical recording medium and the virtual center point M2 of the track coincide with each other. Thus, if an optical recording medium is formed according to the standard that is set according to a type of the optical recording medium, pit strings of the optical recording medium are fit in the respective sections bi. Note that, in FIG. 10, the inclination θ with respect to the upper side and the lower side of the straight lines Lt is drawn larger than an actual inclination θ for convenience of explanation.

When the center point M1 of the optical recording medium and the virtual center point M2, which is the center of the track, coincide with each other judging from the track information calculated by the track-information calculating unit 5, as explained in the first embodiment, the image-analysis-path generating unit 13 performs processing for reducing or enlarging the standard image analysis path based on a ratio of the standard track pitch and the actual track pitch and superimposing straight lines of the expanded recording surface image and straight lines of the image analysis path. When the center point M1 of the optical recording medium and the virtual center point M2, which is the center of the track, do not coincide with each other judging from the track information calculated by the track-information calculating unit 5, the image-analysis-path generating unit 13 performs processing for converting the straight lines Lt in the track direction of the image analysis path into sine curves based on an eccentric component calculated by the track-information calculating unit 5, reducing or enlarging the image analysis path based on a ratio of the standard track pitch and the actual track pitch, and superimposing the image analysis path on the expanded recording surface image. The processing for reducing or enlarging the image analysis path based on a ratio of the standard track pitch and the actual track pitch is actually applied only to the part where the straight lines Lt are drawn as in the processing for reducing or enlarging the imaginary spiral by the imaginary spiral generating unit 6 in the first embodiment.

The image processing unit 3 performs processing for using the expanded recording surface image, on which the image analysis path is superimposed, and subjecting the pits to image analysis in order from the pits included in the section b1 on the inner most peripheral side of the image analysis path to obtain information on an arrangement of the pit strings. Note that components identical with the components in FIG. 1 of the first embodiment are denoted by the identical reference numerals and signs and explanations of the components are omitted. In addition, since a procedure of the information reading processing of the optical-recording-medium reading apparatus 1 in the second embodiment is the same as that in the first embodiment, a detailed explanation of the procedure is also omitted.

Note that, in the above explanation, the image expanding unit 12 generates an expanded recording surface image with the straight line passing the center point M1 of the optical recording medium as a reference. However, the image expanding unit 12 may generate an expanded recording surface image with the virtual center point M2, which is calculated by the track-information calculating unit 5, as a center. In this case, it is necessary to expand a recording surface image such that an outer periphery of a circle with the virtual center point M2 as a center changes to a straight line. Pit strings in the expanded recording surface image obtained in this way never form sine curves. Thus, the generation of the image analysis path by the image-analysis-path generating unit 13 is only transformation processing according to a difference between the actual track pitch and the standard track pitch.

The image expanding unit 12 may expand a recording surface image by an amount equivalent to 1+α times of rotation to make it easy to obtain a point where a last end of a certain pit string and a first end of the next pit string coincide with each other.

According to the second embodiment, the image analysis is performed using an expanded recording surface image obtained by expanding a circular recording surface image picked up by the imaging unit 2 such that an outer periphery thereof changes to a linear shape. Thus, pit strings change to substantially a linear shape and the image analysis unit 7 only has to perform the image analysis along a straight line in order from a predetermined position. Therefore, the processing is made easy. In addition, since the pit strings are arranged substantially in a linear shape, a pit string connecting to a pit string of a certain line is a pit string of the next line. Thus, it is possible to reduce an error of misreading.

According to the first and the second embodiments, a warp, a side-runout, and the like of the optical recording medium are not taken into account. If a warp or a side-runout occurs in the optical recording medium, the imaging unit is defocused. Thus, an example of an optical-recording-medium reading apparatus coping with such a warp and a side-runout is explained.

FIG. 11 is a diagram of an example of a structure of an imaging unit according to a third embodiment of the present invention. Rollers 31A and 31B, which feed the optical recording medium 100 while pressing the same at a predetermined pressure, are arranged near the front and the back of the imaging unit 2. Consequently, in parts of the optical recording medium 100 in contact with the rollers 31A and 31B, a warp of a surface of the optical recording medium 100 is controlled to make the surface flat. Since a position where the imaging unit 2 is arranged is in the middle of the two rollers 31A and 31B, it is considered that the warp is practically eliminated. Thus, it is possible to pick up an image in focus. Note that the rollers 31A and 31B correspond to a pressing unit in patent claims.

FIG. 12 is a diagram of another example of the structure of the imaging unit according to the third embodiment. The imaging unit 2 is provided inside a transparent roller 32 that feeds the optical recording medium 100 while pressing the same at a predetermined pressure. Consequently, it is possible to pick up an image with the imaging unit 2 at an instance when the optical recording medium 100 is pressed by the roller 32. As a result, it is possible to pick up an image in focus. Note that this roller 32 corresponds to the pressing unit in patent claims.

Besides, for example, a focus servo mechanism used in the optical pickup of the optical recording medium reproducing apparatus may be provided in the respective image pickup devices 22 constituting the imaging unit 2. It is also possible that the imaging unit 2 includes a detection unit that detects a distance between the image pickup devices 22 and a surface layer of a recording surface of an optical recording medium. In this case, the detection unit detects a distance between the image pickup devices 22 and the surface layer of the recording surface due to a warp. The support member 21 supporting the image pickup devices 22 is transformed to keep the distance between the image pickup devices 22 and the recording layer at a predetermined value according to a result of the detection.

According to the third embodiment, even if an optical recording medium has a warp or a side-runout, it is possible to pick up an image focused on pit strings formed on a recording surface of the optical recording medium.

Usually, in an optical recording medium such as a CD, a unit length of pit strings (hereinafter, “linear velocity”) is set to a predetermined value (a standard value) and respective pits are formed with this linear velocity as a reference. However, actually, linear velocity fluctuates compared with the reference depending on a product (an optical recording medium). Therefore, when pit strings of an optical recording medium, a linear velocity of which deviates from the standard, is read with the standard linear velocity as a reference, irregularity occurs in read information.

Thus, a fourth embodiment of the present invention is characterized in that the track-information calculating unit 5 in the first to the third embodiments further has a function of calculating fluctuation in a linear velocity. The track-information calculating unit 5 further has a function of extracting a longest pit from a recording surface image on the image memory 4, defining that the length corresponds to a length of a longest pit defined by a standard, and calculating a ratio of the length of the extracted pit and the length of the longest pit of the standard as fluctuation in a linear velocity.

The image analyzing unit 7 reads pit strings based on the fluctuation in a linear velocity calculated by the track-information calculating unit 5. When the pit strings are read with a reference length of pits as a unit, the unit is corrected according to the calculated fluctuation in a linear velocity. Consequently, even when a linear velocity deviates from the standard, processing for reading pit strings is performed accurately.

According to the fourth embodiment, a rate of deviation from the standard linear velocity is calculated for a linear velocity of an optical recording medium and processing for reading pit strings is performed based on the rate. Thus, even when a linear velocity deviates from a linear velocity set as a standard depending on an optical recording medium, it is possible to cope with the deviation.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An optical-recording-medium reading apparatus that performs an image analysis of a track consisting of strings of optically readable pits formed on a recording surface of an optical recording medium, and converts pit arrangement information including lengths and intervals of the pits into a digital signal, the optical-recording-medium reading apparatus comprising:
an imaging unit that captures an image of an entire recording surface of the optical recording medium;
an image storing unit that stores the image of the entire recording surface captured as one image of a recording surface image;
a track-information calculating unit that calculates a virtual center point that is a center of the track of the optical recording medium and an actual track pitch that is an interval between adjacent pit strings of the track in a radial direction of the optical recording medium;
an image-analysis-path generating unit that matches a center of an image analysis path with the virtual center point of the recording surface image stored in the image storing unit, the image analysis path being obtained by transforming a standard image analysis path of a spiral shape for performing the image analysis of pits from an innermost periphery to an outermost periphery of the track having a standard track pitch that is set according to a type of the optical recording medium to be superimposed on the actual track pitch calculated; and
an image analyzing unit that performs the image analysis of the pits sequentially from the innermost periphery according to the image analysis path, and converts the pit arrangement information of the track into a digital signal, and stores the digital signal converted.

2. The optical-recording-medium reading apparatus according to claim 1, wherein the track-information calculating unit calculates a midpoint between one pit on the innermost periphery and other pit on the innermost periphery farthest from the one pit as a virtual center point.

3. The optical recording medium reading unit according to claim 1, wherein the track-information calculating unit calculates the actual track pitch by measuring a distance between a first pit string and a second pit string apart from the first pit string in the radial direction by N strings, and dividing the distance by N, where N is a positive integer.

4. The optical-recording-medium reading apparatus according to claim 1, further comprising an image expanding unit that generates an expanded recording surface image that is obtained by expanding the recording surface image stored in the image storing unit with an arbitrary straight line having a length of a radius drawn from a center point determined from a shape of the optical recording medium as a reference, such that an outer periphery of the optical recording medium becomes a straight line, wherein
the image-analysis-path generating unit has a standard image analysis path of a shape obtained by expanding the standard image analysis path such that the outer periphery of the optical recording medium becomes a straight line.

5. The optical-recording-medium reading apparatus according to claim 4, wherein when the center point of the optical recording medium and the virtual center point do not coincide with each other, the image-analysis-path generating unit transforms a component in a track direction of the standard image analysis path into a sine curve shape based on deviations of both the center point and the virtual center point.

6. The optical-recording-medium reading apparatus according to claim 1, further comprising an image expanding unit that generates an expanded recording surface image that is obtained by expanding the recording surface image stored in the image storing unit with an arbitrary straight line having a length of a radius drawn from the virtual center point as a reference such that an outer periphery of a circle with the virtual center point becomes a straight line, wherein
the image-analysis-path generating unit has a standard image analysis path of a shape obtained by expanding the standard image analysis path such that the outer periphery of the optical recording medium becomes a straight line.

7. The optical-recording-medium reading apparatus according to claim 4, wherein the straight line drawn from the center point is a straight line passing the pits on the innermost periphery forming the track.

8. The optical-recording-medium reading apparatus according to claim 6, wherein the straight line drawn from the virtual center point is a straight line passing the pits on the innermost periphery forming the track.

9. The optical-recording-medium reading apparatus according to claim 1, wherein the imaging unit has a function of keeping a focal length at a predetermined value when capturing the image of the optical recording medium.

10. The optical-recording-medium reading apparatus according to claim 1, further comprising a pressing unit that feeds the optical recording medium while applying a pressure to keep a distance from the imaging unit to a surface on a side of the recording surface the optical recording medium at a predetermined value.

11. The optical-recording-medium reading apparatus according to claim 1, wherein
the track-information calculating unit calculates a fluctuation in a linear velocity that is a unit length of pits from the recording surface image, and
the image analyzing unit performs the image analysis of the pit strings according to the fluctuation calculated.
